(19) United States
(12) Patent Application Publication
(10) Pub. No.: US 2025/0375865 A1
(43) Pub. Date: Dec. 11, 2025

(54) FASTENING TOOL HAVING POSITION BIASED RELEASED VALVE

(71) Applicant: BLACK & DECKER, INC., New Britain, CT (US)

(72) Inventors: Luke MOLOZNIK, Baltimore, MD (US); Stuart GARBER, Towson, MD (US)

(21) Appl. No.: 18/876,496

(22) PCT Filed: Jun. 21, 2023
(86) PCT No.: PCT/US2023/068777

§ 371 Date: Dec. 18, 2024

Related U.S. Application Data
(60) Provisional application No. 63/354,303, filed on Jun. 22, 2022.

(51) Int. Cl. B25C 1/04; B25C 1/00; B25C 1/06

(52) U.S. Cl. CPC B25C 1/042; B25C 1/001; B25C 1/06

(57) ABSTRACT

A fastening tool comprises a driver member, a controller configured to control a supply of power from a power source to a motor and to initiate a drive cycle, a piston configured to travel between at least two positions in a compression cylinder, a drive assembly, a drive cylinder, and a valve assembly operatively connected with drive cylinder and the compression cylinder. The driver member is at least partially disposed within the drive cylinder for movement along a drive axis to drive a lead fastener into a workpiece. The piston is configured to engage with and open the valve assembly to release the buildup of air in the compression cylinder, due to the travel of the piston between the at least two positions in the compression cylinder, to the drive cylinder so as to move the driver member along the drive axis to drive the lead fastener into the workpiece.

### CROSS-REFERENCE TO RELATED APPLICATIONS

The present patent application claims priority to U.S. Provisional Patent Application Ser. No. 63/354,303 (“the '303 Provisional Patent Application”) entitled “Fastening Tool Having Position Based Release Valve”, filed Jun. 22, 2022. The entirety of this application is incorporated herein by reference.

The present patent application is also related to PCT/US2022/24929 (“the PCT '929”) entitled “Fastening Tool Having Home Position Sensing System”, filed Apr. 14, 2022, which claims priority to U.S. Provisional Patent Application Ser. No. 63/174,950 entitled “Fastening Tool Having Home Position Sensing System”, filed Apr. 14, 2021. The entirety of each of the above applications are incorporated herein by reference.

### BACKGROUND

### Field

The present patent application relates, in general, to the field of power tools. In particular, the present patent application relates to a fastening or driving tool, such as a nailer and more particularly to improvements in such tools for sensing the position of components therein. In particular, the present patent application relates to a fastening tool having a compression piston position release valve that releases the build-up of air in the compression cylinder chamber based on the position of the compression piston.

### Description of the Related Art

Different types of fastening tools are known including portable pneumatically actuated devices, electrically actuated devices, hammer actuated devices, manual actuated devices, etc. Fastening tools, such as power nailers have become relatively common place in the construction industry. Battery-powered nailers are popular in the market.

A common characteristic of all these types of fastening tools is the provision of a drive track, a fastener driving element mounted in the drive track and a magazine assembly for receiving a supply of fasteners in stick formation and feeding successive leading fasteners in the stick laterally into the drive track to be driven outwardly thereof by the fastener driving element. Current air pressure release valves have issues with consistency in the release. The valves are affected by temperature and therefore suffer from misalignment and incomplete returns. Such conditions can cause a failure to execute a drive cycle or cause early release resulting in a less than predetermined force required for driving of the driver member.

U.S. Pat. No. 8,079,504 discloses a fastener driving apparatus. The fastener driving apparatus includes a retention element (e.g., at least one of a magnet, a mechanical detent a frictional interference, and a solenoid) that is configured to retain a driver at its topmost position in a driver cylinder until a sufficient force/pressure is applied on the driver.

### SUMMARY

Features and benefits of the present patent application are described, and will be apparent from, the accompanying drawings and the detailed description below.

In an aspect, a fastening tool is provided. The fastening tool comprises a housing; a nosepiece assembly connected with the housing and including a fastener drive track having a drive axis; a magazine assembly for feeding a number of fasteners successively along a fastener channel of the fastener drive track; a driver member provided in the housing and configured for movement along the drive axis to drive a lead fastener into a workpiece; a motor disposed in the housing; a power source configured to provide power to the motor; a controller disposed in the housing and configured to control a supply of power from the power source to the motor and to initiate a drive cycle; a compression cylinder assembly disposed in the housing, the compression cylinder assembly comprising a compression cylinder and a piston that is configured to travel between at least two positions in the compression cylinder; a drive assembly operatively connected to the motor, the drive assembly operatively connected to the piston to facilitate the travel of the piston in the compression cylinder; a drive cylinder disposed in the housing, the driver member at least partially disposed within the drive cylinder for movement along the drive axis, the drive cylinder being operatively connected with the compression cylinder; and a valve assembly operatively connected with drive cylinder and the compression cylinder. The piston is configured to engage with and open the valve assembly to release the buildup of air in the compression cylinder, due to the travel of the piston between the at least two positions in the compression cylinder, to the drive cylinder so as to move the driver member along the drive axis to drive the lead fastener into the workpiece.

Exemplary and non-limiting implementations of the foregoing aspects may include one or more of the following features.

The valve assembly may be a piston position biased release valve assembly.

The valve assembly may include a spring and a valve portion. The spring may be configured to bias the valve portion to close the valve assembly. The piston may be configured to engage with and force the valve portion, against the bias of the spring, to open the valve assembly.

The valve assembly may comprise a valve stem, a valve stem spring, a valve insert, an end cap, and an O-ring. The valve stem spring may be configured to bias the valve stem towards the O-ring and the valve insert to close the valve assembly. The valve stem may have a first surface and an opposing second surface. The valve stem also may include a base portion and two valve stem portions extending from the base portion. The valve insert may include two openings configured to receive the two valve stem portions of the valve stem respectively therein.

The end cap may have a first surface and an opposing second surface. The first surface of the end cap may face the second surface of the valve stem. The valve assembly may also include a valve chamber between the second surface of the valve stem and the first surface of the end cap. The valve chamber may be configured to be operatively connected to the compression cylinder. The valve chamber may also be configured to be operatively connected to the drive cylinder when the valve assembly is open.

The at least two positions in the compression cylinder between which the piston travels may include a top dead center position and a bottom dead center position. The top dead center position may be positioned near the valve assembly.

During a compression cycle, the piston may be moved by the drive assembly from the bottom dead center position to the top dead center position to increase the pressure in the compression cylinder. During the compression cycle, the valve stem may be held against the O-ring and the valve insert to form a seal between the valve stem and the O-ring so as to seal off the driver cylinder from the compression cylinder. The valve stem may be held against the O-ring and the valve insert by bias of the valve stem spring.

When the piston reaches the top dead center position, (1) the valve stem is held against the O-ring and the valve insert by bias of the valve stem spring and by the pressure of air in the valve chamber, and (2) the piston may contact and force the valve stem, against the bias of the valve stem spring and against the pressure of air in the valve chamber, to break the seal between the valve stem, the O-ring and the valve insert so as to allow the air in the valve chamber and the compression cylinder to enter the drive cylinder. The air entering the drive cylinder may be configured to move the driver member along the drive axis to drive the lead fastener into the workpiece.

The fastening tool may further comprise an exhaust valve that is configured to exhaust any remaining pressure from the driver cylinder after the driver member has driven the lead fastener into the workpiece so that the fastening tool returns to an atmospheric pressure.

The exhaust valve may include a one-way check valve.

The drive cycle may include a drive stroke in which the driver member moves from a home position at the top of the drive cylinder toward the nosepiece assembly along the drive axis and drives the lead fastener into the workpiece, and a return stroke in which the driver member is returned to its home position so that the driver member is ready for the next drive stroke.

When the piston is returned from the top dead center position to the bottom dead center position by the drive assembly, the piston may draw vacuum into the drive cylinder. The vacuum may be configured to cause the driver member to return to its home position and the fastening tool to return to the atmospheric pressure. The valve stem spring may be configured to bias the valve stem to be held against the O-ring and the valve insert to form the seal between the valve stem and the O-ring when the driver member has returned to its home position.

The housing may include a trigger assembly that activates the drive cycle that causes the piston to travel between at least two positions within the compression cylinder. The controller may be configured to connect the trigger assembly to the drive assembly.

The housing may define a handle portion. The trigger assembly may be connected to the housing adjacent to the handle portion.

The drive assembly may include a drive shaft that is operatively connected to the piston to facilitate the travel of the piston in the compression cylinder.

In another aspect, a method of operating a fastening tool, which is discussed above, is provided. The method comprises actuating the drive assembly to move the piston to travel between the at least two positions in the compression cylinder; and engaging the piston with the valve assembly to open the valve assembly and to release the buildup of air in the compression cylinder, due to the travel of the piston between the at least two positions in the compression cylinder, to the drive cylinder so as to move the driver member along the drive axis to drive the lead fastener into the workpiece.

Advantages may include one or more of the following. The impact tools and methods may lead to improved control and speed of fastening operation, while increasing power delivered when needed for impacting and reducing the use of unneeded power, thus saving energy, being more efficient, and protecting tool components from damage. These and other advantages and features will be apparent from the description, the drawings, and the claims.

### BRIEF DESCRIPTION OF THE DRAWINGS

The numerous advantages of the present patent application may be better understood by those skilled in the art by reference to the accompanying Figures. In the drawings, like reference numerals designate corresponding parts throughout the several views.

FIG. 1 is a side view of an exemplary fastening tool constructed in accordance with the teachings of the present disclosure with a portion of the housing removed to show the trigger assembly, battery pack mount and drive motor assembly;

FIG. 2 is a cross-sectional view of the tool of FIG. 1;

FIG. 3 illustrates a sub-assembly of the tool of FIG. 1 including a valve assembly, a compression cylinder assembly, a drive cylinder with a driver member, and a driver blade of the tool of FIG. 1;

FIG. 4 illustrates an assembled configuration of the valve assembly of FIG. 3;

FIG. 5 illustrates an exploded configuration of components of the valve assembly of FIG. 3;

FIG. 6 illustrates a section view of the sub-assembly of FIG. 3;

FIG. 7 illustrates the sub-assembly of FIG. 3 at rest;

FIG. 8 illustrates the sub-assembly of FIG. 3 during compression;

FIG. 9 illustrates the sub-assembly of FIG. 3 in which a compression piston reaching the top dead center position;

FIG. 10 illustrates the sub-assembly of FIG. 3 in which high pressure entering the drive cylinder;

FIG. 11 illustrates the sub-assembly of FIG. 3 with the pressure exhausted;

FIG. 12 illustrates the sub-assembly of FIG. 3 with the compression piston returning to the bottom dead center position, respectively; and

FIG. 13 illustrates the sub-assembly of FIG. 3 with the compression piston at the bottom dead center position.

### DETAILED DESCRIPTION

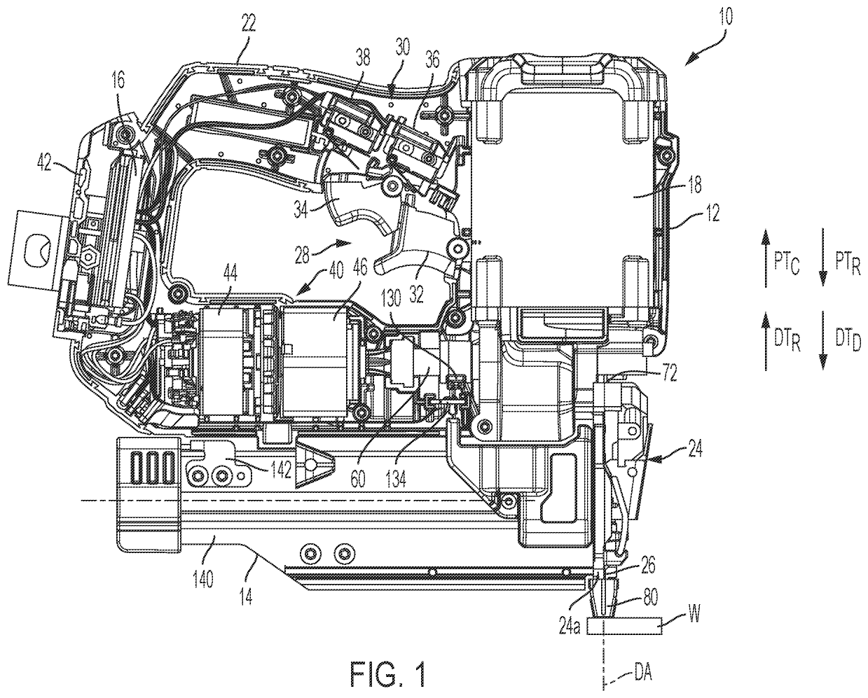

FIG. 1 illustrates a fastening tool 10 according to an embodiment of the present patent application.

According to several aspects, the fastening tool 10 is a battery powered nailer, however the fastening tool can be any type of portable tool including a battery powered compressed air nailer or pneumatic nailer. The fastening tool 10 may be referred to an “air pump” style nailer that is battery powered and configured to produce its own compressed air.

The fastening tool 10 includes a housing 12 containing a compression cylinder 18, a nosepiece assembly 24 extending forward of and fixed to the housing 12, a magazine assembly 14, a control module or controller 16, a trigger assembly 28 and a drive motor assembly 40.

The magazine assembly 14 is connected to a nose portion 24a of the nosepiece assembly 24. The nosepiece assembly 24 is coupled to the drive motor assembly 40 and defines a fastener drive track 26 through which fasteners, such as nails, are driven. That is, the nosepiece assembly 24 is connected to the housing 12 and includes the fastener drive track 26 having a drive axis DA. The fastener drive track 26 may interchangeably referred to as drive track. The controller 16 may be disposed in the housing 12 and may be configured to control a supply of power from a power source (not shown) to a motor 44 of the drive motor assembly 40. The motor 44 is disposed in the housing 12. The power source may be configured to provide power to the motor 44. The fastening tool 10 is designed to drive one or more fasteners into a workpiece W.

Fasteners can be temporarily contained in the magazine assembly 14, which can be connected to the nosepiece assembly 24. The magazine assembly 14 can include a fixed magazine portion 140 and a movable magazine portion (not shown) slidably disposed on the fixed magazine portion 140. The fixed magazine portion 140 and the movable magazine portions are held together by a magazine latch 142. The magazine assembly 14 is configured for feeding a number of fasteners successively along a fastener channel of the fastener drive track 26. The magazine assembly 14 is constructed and arranged to feed successive leading fasteners from a supply of fasteners inserted between the fixed magazine portion 140 and the movable magazine portion, along the feed track or fastener channel and into the drive track 26 of the nosepiece assembly 24. In an embodiment, the supply of fasteners can be collated fasteners. The supply of fasteners is urged toward the drive track 26 by at least one magazine pusher or plurality of pushers that are slidably disposed in grooves in the magazine assembly 14. The magazine pusher or pushers travels along a magazine pusher path or fastener channel. The magazine pusher or pushers can be biased towards the drive track 26 by a spring or plurality of springs (not shown) that push respective pushers toward the drive track 26. The magazine pusher or pushers engages the last fastener in the supply of fasteners to thereby feed individual fasteners from the magazine assembly 14 to the nosepiece assembly 24.

The fasteners can be nails, staples, brads, clips or any such suitable fastener that can be driven into the workpiece W.

In an embodiment, a no-mar tip 80 can be attached to the nose portion 24a of the nosepiece assembly 24 to prevent marring of the workpiece when the nose is placed against the workpiece for driving the fastener.

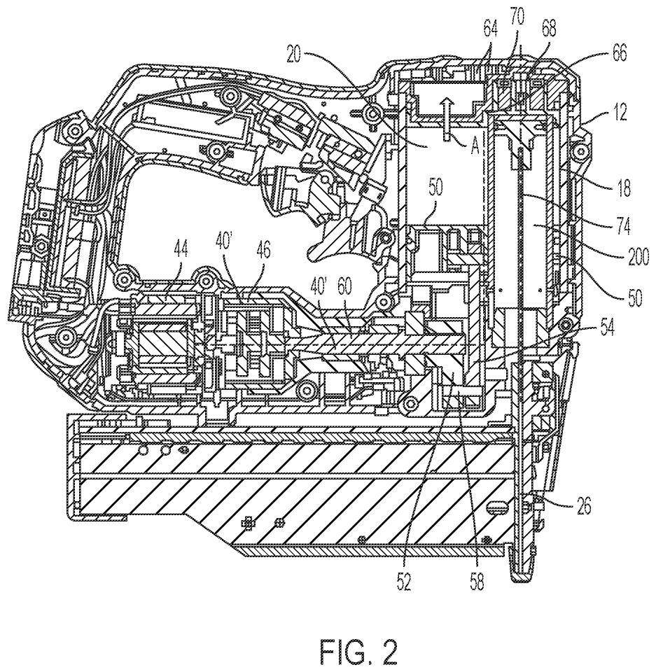

As illustrated in FIGS. 1 and 2, the fastening tool 10 defines a handle portion and the handle portion of the fastening tool 10 extends substantially perpendicularly from the housing 12. The handle portion may interchangeably referred to as handle. The handle 22 is configured to be received by a user's hand, thereby making the fastening tool 10 portable. Additional portability can be achieved by constructing the housing 12 from a lightweight yet durable material, such as plastic or magnesium.

The housing 12 includes the trigger assembly 28. The trigger assembly 28 is connected to the housing 12 adjacent to the handle portion 22. The trigger assembly 28 is pivotably connected to the handle 22. The trigger assembly 28 serves as an actuation device or actuator for the fastening tool 10, and is constructed and arranged to actuate a trigger switch assembly 30. The trigger assembly 28 may be coupled to the housing 12 and is configured to receive an input from the user, typically by way of the user's finger(s), that may be employed in conjunction with the trigger switch assembly 30 to generate a trigger signal that may be employed, in part, to initiate the drive cycle of the fastening tool 10 to drive the fastener into the workpiece W. As will be clear from the discussions below, the trigger assembly 28 is configured to initiate/activate the drive cycle of the fastening tool 10 that causes a compression piston 50 to travel between at least two positions within the compression cylinder 18. The controller 16 is configured to connect the trigger assembly 28 to a drive assembly 40′.

The trigger assembly 28 includes a primary trigger 32 and a secondary trigger 34. The trigger switch assembly 30 includes a primary switch 36 that is actuated by the primary trigger 32 and a secondary switch 38 that is actuated by the secondary trigger 34. The primary and secondary triggers 32, 34 are pivotably mounted to the handle 22 so as to be grasped by the user's finger(s) when the user holds the tool 10 by hand along the handle 22.

In operation, the secondary trigger 34 is actuated or pulled first to activate the secondary switch 38 that sends a signal to the controller 16 to power the fastening tool 10. Upon detecting the actuation of the secondary trigger 34, the controller 16 can instruct the power source to deliver power to the fastening tool 10. Powering of the fastening tool 10 includes the activation of any lights and sensors for checking for fasteners in the magazine assembly 14. After the secondary trigger 34 is pulled, the primary trigger 32 is actuated or pulled to activate the primary switch 36. The primary switch 36 sends a signal to the controller 16 to activate the drive motor assembly 40. The primary and secondary switches 36, 38 may be disposed within the handle portion 22 of the fastening tool 10.

The controller 16 is configured to actuate the power source for initiating the operation cycle for driving the fastening tool 10. The controller 16 is configured to deactivate the power source after completion of the operation cycle for driving the fastening tool 10. The controller 16 is configured to control the operation of the motor 44 by activating or deactivating the power source. As used herein, the term controller can refer to an application specific integrated circuit (ASIC), an electronic circuit, a processor (shared, dedicated, or group) and memory that executes one or more software or firmware programs, a combinational logic circuit, other suitable components and/or one or more suitable combinations thereof that provide the described functionality.

The drive motor assembly 40 of the fastening tool 10 extends from the nosepiece assembly 24 and includes additional components necessary for activating the fastening tool 10 and driving the fastener. In an embodiment, the drive motor assembly 40 may extend substantially perpendicularly within the housing 12. Alternatively, the drive motor assembly 40 may extend substantially perpendicularly within a separate drive assembly housing. The drive motor assembly 40 can be disposed between the power source and the nosepiece assembly 24. The drive motor assembly 40 includes a motor 44, a transmission gear system 46 and a drive shaft 60. The transmission gear system may be interchangeably referred to as transmission system or gear assembly. The drive motor assembly 40 may include the motor and the drive assembly 40′. The drive assembly 40′ includes the transmission system 46 and the drive shaft 60. The drive assembly 40′ may be operatively connected to the motor 44. The drive assembly 40′ may also be operatively connected to the piston 50 to facilitate the travel of the piston 50 between at least positions in the compression cylinder 18.

The motor 44 is electrically connected to the power source. The motor 44 may be electrically connected to the power source by means of various means and mechanisms, such as an electric wire or a magnetic coupling. The motor 44 is further responsive to the controller 16. The controller 16 is configured to direct the power from the power source to the motor 44 for initiating the operation cycle of driving the fastener into the workpiece W. Similarly, the controller 16 is configured to disconnect the power from the power source to the motor 44 after completion of the operation cycle. The motor 44 may include a dynamic braking system for halting the rotations of the motor 44. Further, in one embodiment of the present disclosure, the fastening tool 10 may include a switch for directing and disconnecting the power from the power source to the motor 44 through the controller 16. The switch may be controlled by the controller 16 for appropriately actuating the starting and stopping of the operation cycle of fastening tool 10. The switch may be an ON/OFF switch. The motor 44 is configured to impart a reciprocating movement to a piston 50 in the compression cylinder 18/20. The motor 44 provides the reciprocating movement to the piston 50 through the drive mechanism/assembly. The drive mechanism may include linear motion converter that is configured to convert the rotational motion of the motor 44 into linear reciprocating movement of the piston 50 within the compression cylinder 18/20.

The linear motion converter may be driven by the motor 44. The linear motion converter may be driven by the motor 44 through a speed reduction mechanism. The speed reduction mechanism is configured to reduce the revolutions per minute (rpm) of the motor 44 depending upon a required speed of reciprocating movement of the piston 50. The speed reduction mechanism may be a gear reduction mechanism. The speed reduction mechanism may also comprise a flywheel, gearbox and/or a clutch. The speed reduction mechanism is connected to the linear motion converter through a shaft. The linear motion converter may be a crankshaft mechanism. Herein, the linear motion converter includes a crankshaft and a connecting rod connected to the crankshaft.

The speed reduction mechanism may be coupled to the crankshaft for transmitting the rotational motion generated by the motor 44 to the crankshaft and the connecting rod. The connecting rod is connected to the crankshaft. The connecting rod is connected to the piston 50 (e.g., by means of a piston pin (not shown)). The connecting rod is connected to the crankshaft by means of various means and mechanisms, such as a nut and a bolt, a rivet, and the like.

The power source may supply electrical energy, to operate the motor 44 of the drive motor assembly 40 and the trigger assembly 28. The power source may be configured to provide power for operation of the fastening tool 10. In an embodiment, the power source is a battery pack or a rechargeable battery (not shown). The power source may include another other power source such as an AC power supply. The power source is electrically coupled to the controller 16. The controller 16 is configured to control a supply of power from the power source to the motor 44 to initiate the drive cycle upon receipt of the trigger signal from the primary trigger 32.

In an embodiment, the battery pack can be removably coupled to a battery pack mount 42 at the distal end of the handle 22 and distal end of the drive motor assembly 40. For example, the battery pack can be slidably mounted onto and slidably released from the battery pack mount 42.

The drive motor assembly 40 operatively connects the motor 44 with the drive shaft 60. As such, upon activation of the motor 44 and transmission gear system 46, the drive shaft 60 rotates. The drive shaft 60 is configured to be operatively connected to the compression piston 50 to facilitate the travel of the compression piston 50 between at least two positions in the compression cylinder 18/20. The drive shaft 60 drives the operation of the compression cylinder 18/20. The compression cylinder 18 controls the operation of a driver member 72 that drives a fastener out of the fastening tool 10. The drive shaft 60 transmits power from the motor 44 to the compression piston 50. The presence and/or absence of compressed air in the compression cylinder 18 directs the driver member 72 to translate within the drive track 26. The presence or absence of compressed air is controlled by the compression piston 50 disposed in the compression cylinder 18/20.

The compression piston 50 is moveable within the compression cylinder 18/20 by a reciprocating connecting rod 54. The drive shaft 60 is connected to the compression piston 50 through an operatively connected eccentric member 52 and connecting rod 54. The connecting rod 54 is connected to the eccentric member 52 by a pin 58. The eccentric member 52 converts the rotary motion of the drive shaft 60 into linear reciprocating motion of the connecting rod 54 to drive the compression piston 50.

As illustrated in FIGS. 1 and 2, the housing 12 includes the compression cylinder 18 in which a gas, such as air is compressed. In particular, the compression cylinder 18 contains a first compression chamber 20 and a second compression chamber 200. The first compression chamber 20 and second compression chamber 200 are substantially defined within the compression cylinder 18. The first compression chamber 20 generates compressed air in the tool 10.

The first compression chamber 20 may interchangeably be referred to as a compression cylinder, while the second compression chamber 200 may interchangeably be referred to as a drive cylinder.

The compression cylinder 20 may be part of a compression cylinder assembly that is disposed in the housing 12. The compression cylinder assembly includes the compression cylinder 20 and the compression piston 50. The compression piston 50 may interchangeably referred to as piston and is configured to travel between at least two positions in the compression cylinder 20. The at least two positions in the compression cylinder 20 between which the piston 50 travels include a top dead center position TDCP and a bottom dead center position BDCP. The top dead center position TDCP is where the piston 50 (and its head) is positioned at one of the ends of the drive cylinder 20 that is near a valve assembly VA, while the bottom dead center position BDCP is where the piston 50 (and its head) is positioned at the other (opposing) end of the drive cylinder 20. The top dead center position TDCP of the piston 50 may interchangeably referred to as the top dead center of the compression cylinder 20. The bottom dead center position BDCP of the piston 50 may interchangeably referred to as the bottom dead center of the compression cylinder 20.

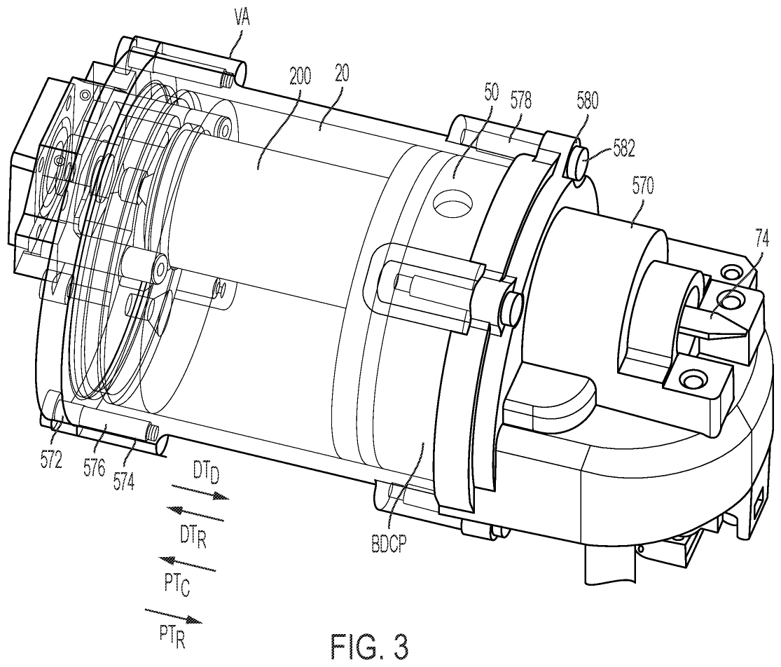

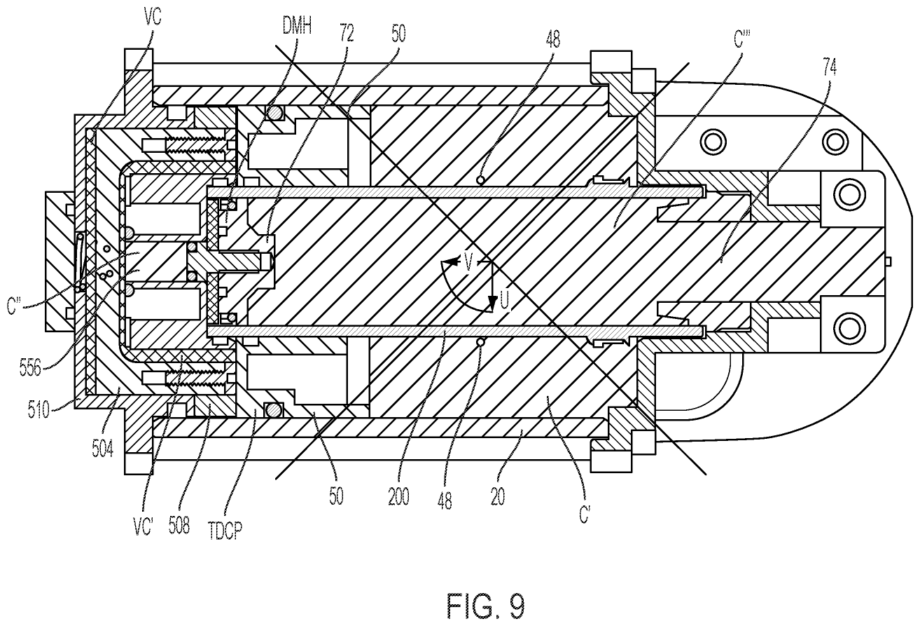

A compression cycle/stroke is when the piston 50 travels from the bottom dead center position BDCP to the top dead center position TDCP, while a return cycle/stroke is when the piston 50 travels from the top dead center position TDCP to the bottom dead center position BDCP. The stroke and the cycle may be interchangeably used in this patent application. The piston 50 may be moved between the top dead center position TDCP and the bottom dead center position BDCP by the drive assembly 40′. That is, the piston 50 may be moved by the drive assembly 40′ during the compression cycle and the return cycle. The piston 50 is shown positioned at its bottom dead center position BDCP in FIGS. 3, 6-7 and 13. The piston 50 is shown positioned at its top dead center position TDCP in FIGS. 9-11.

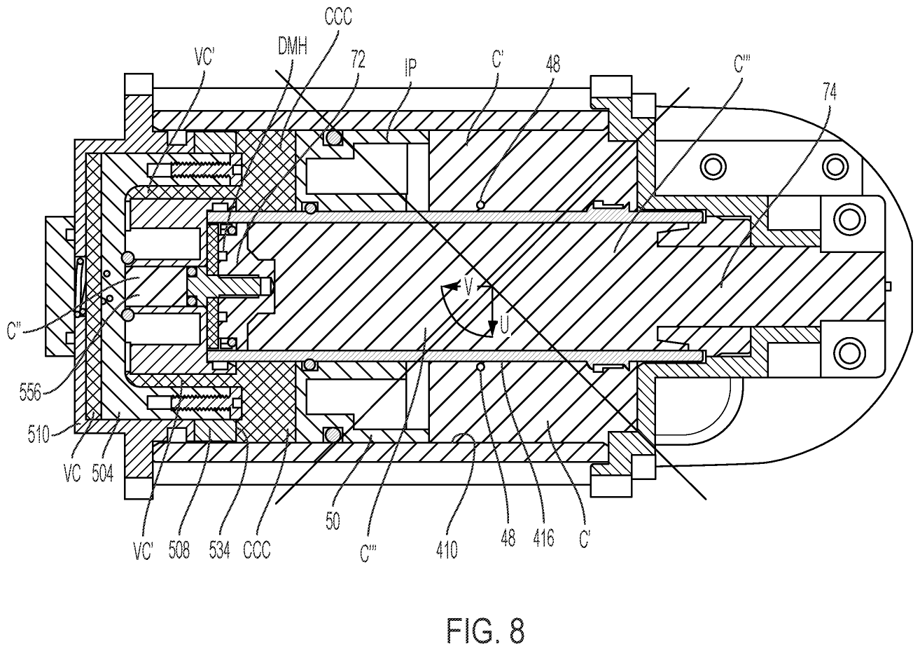

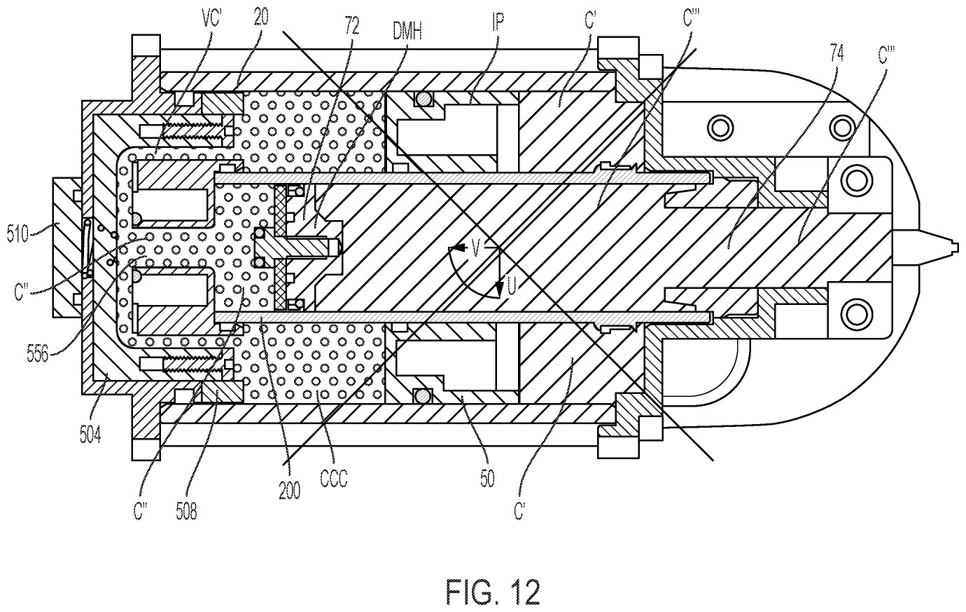

The piston 50 may also travel through a plurality of intermediate positions IP, between the top dead center position TDCP and the bottom dead center position BDCP, in the compression cylinder 20. The piston 50 is shown positioned at its intermediate positions, during the compression cycle, in FIG. 8. The piston 50 is shown positioned at its intermediate positions, during the return cycle, in FIG. 12.

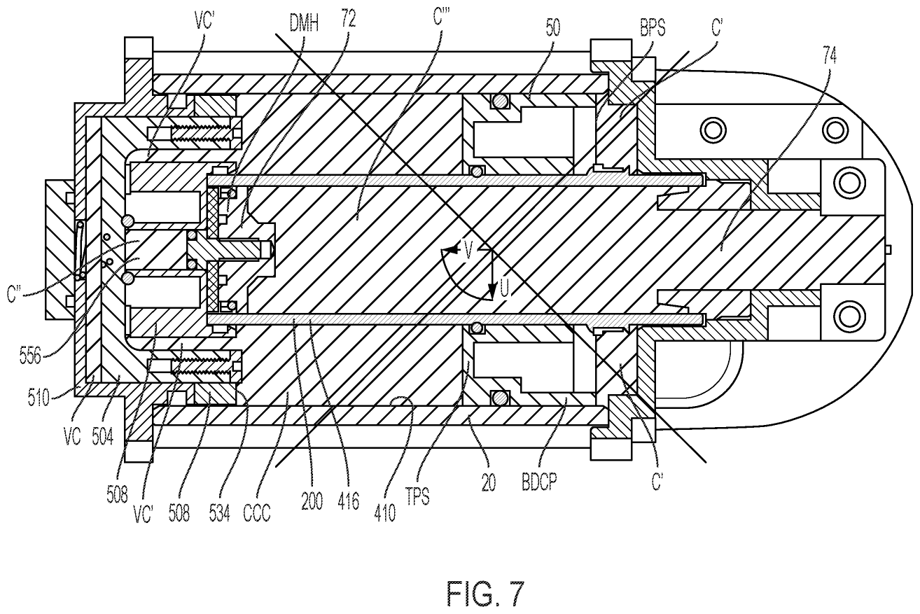

The compression cylinder 20 may have a volume that is proportional to the amount of energy required for driving the fastener into the workpiece W. Before starting the compression stroke, a gas chamber CCC (i.e., disposed in the compression cylinder 20 and positioned above the top surface TPS of piston as shown in FIGS. 7-13) may have a volume of the gas stored therein, which is proportional to the amount of energy required for driving the fastener into the workpiece W.

The drive cylinder 200 may be disposed in the housing 12. The driver member 72 may at least be partially disposed within the drive cylinder 200 for movement along the drive axis DA. The drive cylinder 200 may be operatively connected with the compression cylinder 20.

In one embodiment, the compression cylinder 18/20 may have two chambers. One outer chamber in which the (e.g., toroidal-shaped) piston 50 reciprocates, and the other inner drive chamber 200 in which the driver 72 reciprocates. That is, the compression chamber and the drive chamber may be disposed in the same cylinder. The compression chamber and the drive chamber may be concentric. The drive chamber may be eccentric with respect to the compression chamber.

In another embodiment, the drive cylinder 200 and the compression cylinder 20 may be two different cylinders. The drive cylinder 200 is disposed inside the compression cylinder 20. In one embodiment, the drive cylinder 200 is positioned such that the longitudinal axis (i.e., parallel to the drive axis DA) of the drive cylinder 200 and the longitudinal axis (i.e., parallel to the drive axis DA) of the compression cylinder 20 are parallel to each other and are spaced apart from each other. For example, the drive cylinder 200 may be positioned to be eccentric with respect to the compression cylinder 20. In another embodiment, the drive cylinder 200 is positioned such that the longitudinal axis of the drive cylinder 200 and the longitudinal axis of the compression cylinder 20 may be parallel to each other and are the same. For example, the drive cylinder 200 may be positioned to be concentric with respect to the compression cylinder 20. Although the drive cylinder 200 and the compression cylinder 20 are shown and described as cylindrical shaped chambers, in other embodiments, the drive chamber and the compression chamber may have other shaped configurations. The drive cylinder and the compression cylinder may interchangeably referred to as drive chamber and the compression chamber.

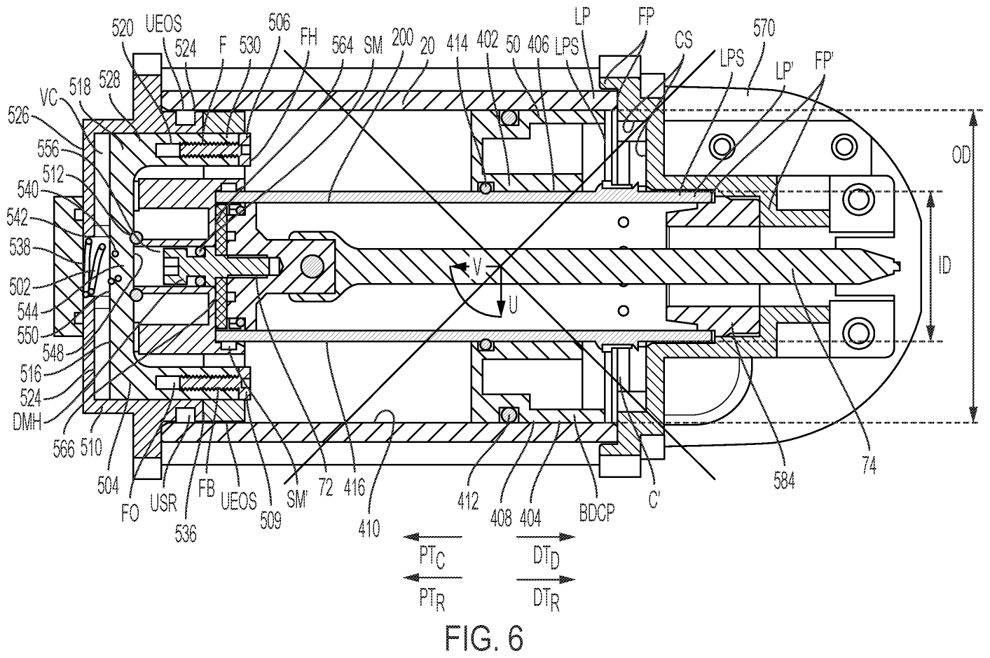

As shown in FIG. 6, the piston 50 may have an inner diameter ID and an inner circumferential surface 402. The inner circumferential surface 402 may form an opening 406 configured to receive the drive cylinder 200 therein such that the inner circumferential surface 402 of the piston 50 is in sliding engagement with respect to an outer circumferential surface 416 of the drive cylinder 200 as the piston 50 travels between the at least two positions in the compression cylinder 20. The piston 50 may have an outer diameter OD and an outer circumferential surface 404. The piston 50 is received in an opening 408 of the compression cylinder 20 such that the outer circumferential surface 404 of the piston 50 is in sliding engagement with respect to an inner circumferential surface 410 of the compression cylinder 20 as the piston 50 travels between the at least two positions in the compression cylinder 20. That is, the piston 50 is movable with respect to the stationary drive cylinder 200 and the stationary compression cylinder 20.

The piston 50 may have piston rings 412 and 414 that are configured to seal the gap between the piston 50 and the drive cylinder 200 and the gap between the piston 40 and the compression cylinder 20. In other words, the piston rings 412 and 414 are configured to seal the combustion chamber 20. For example, the piston ring 412 may be attached to the outer circumferential surface 404 of the piston 50 to seal the gap between the piston 50 and the inner circumferential surface 410 of the compression cylinder 20, while the piston ring 414 may be attached to the inner circumferential surface 402 of the piston 50 to seal the gap between the piston 50 and the outer circumferential surface 416 of the drive cylinder 200.

The number of piston rings disposed on the inner and outer circumferential surfaces of the piston 50 may vary. The piston rings may be received in grooves formed the inner and outer circumferential surfaces of the piston 50 so as to be attached to the respective inner and outer circumferential surfaces of the piston 50. The piston rings may interchangeably be referred to as sealing rings or compression rings. The outer circumferential surfaces and inner circumferential surfaces of the piston 50 and the drive cylinder 200/compression cylinder 20 may interchangeably referred to as outer walls and inner walls, respectively.

The compression cylinder 20 includes top connector receiving holes 576 and bottom connector receiving holes 578. The top connector receiving holes 576 are configured to align with holes 572 of an end cap 510 and to receive fasteners 574 to enable connection between the end cap 510 and the compression cylinder 20 near upper end portions of the compression cylinder 20. The bottom connector receiving holes 578 are configured to align with holes 580 of the lower portion 570 and to receive fasteners 582 to enable connection between the lower portion 570 and the compression cylinder 20 near lower end portions of the compression cylinder 20.

Referring to FIGS. 3 and 6, the fastening tool 100 includes a lower portion 570. The lower portion 570 may include flange portions FP that are shaped and configured to receive and support the lower portions LP of the compression cylinder 20. The lower portion 570 may include flange portions FP′ that are shaped and configured to receive and support portions of a bumper 584 and the lower portions LP′ of the drive cylinder 200. The lower portion 570 has an opening through which the driver blade 74 extends and retracts.

The bumper 584 may be disposed in the lower end portion 570 of the drive cylinder 200. The bumper 584 is configured to absorb excess energy at the end of an expansion stroke, i.e., when the driver blade 74 strikes the fastener. The bumper 584 may be composed of various impact energy absorbing materials, such as an elastomer, and the like. The bumper 584 may have an opening through which the driver blade 74 extends and retracts.

Referring to FIG. 6, the lower portion 570 includes surfaces CS that together with lower surfaces LPS of the piston 50 and outer surfaces 416 of the drive cylinder 200 form a chamber C′.

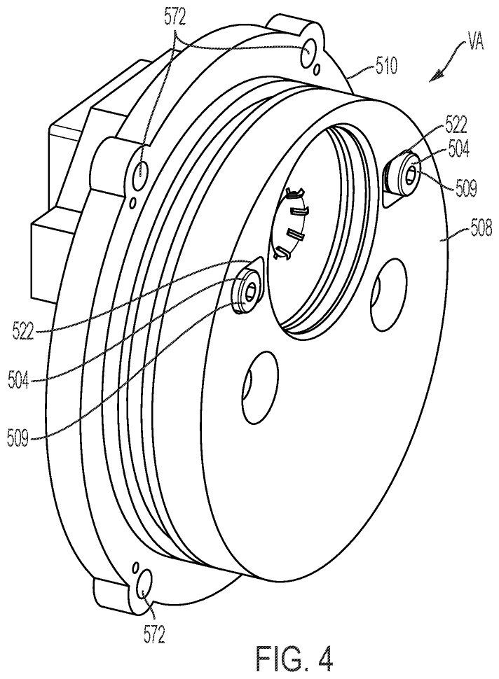

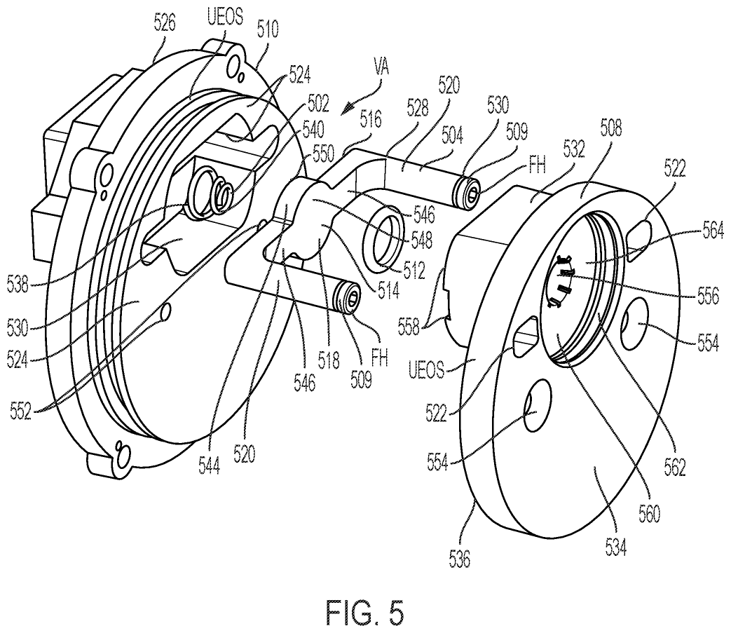

Referring to FIGS. 4-6, the valve assembly VA is a piston position biased release valve assembly. The valve assembly VA includes a spring 502 and a valve portion 504. The spring 502 is configured to bias the valve portion 504 to close the valve assembly VA. The piston 50 is configured to engage with and force (e.g., portions 509 of) the valve portion 504, against the bias of the spring 502, to open the valve assembly VA. The valve portion 504 may interchangeably be referred to as valve stem, and the spring 502 may interchangeably be referred to as valve stem spring. The piston's engagement with portions of the valve assembly VA (e.g., portions 509 of the valve stem 504) include (e.g., direct) contact between the surfaces of the valve assembly VA and the surface of the piston 50 so that the piston 50 can then force the portions 509 of the valve portion 504, against the bias of the spring 502, to open the valve assembly VA.

The valve assembly comprises the valve stem spring 502, the valve stem 504, a valve insert 508, an end cap 510, and an O-ring 512.

The spring 502 has a first end 538 and a second end 540. The spring 502 may interchangeably be referred to as resilient bias member. The spring 502 may be a coil spring that is configured to store energy (when it is being compressed against its bias) and subsequently release the stored energy, or to maintain a constant force between surfaces of the end cap 510 and the valve stem 504. The spring 502 may be a conical/tapered/conical tapered spring with a larger outer diameter at the first end 538 and a smaller outer diameter at the second end 540. The spring 502 may have a predetermined free length when the spring 502 is in an uncompressed state and a predetermined solid length when the spring 502 is in a compressed state. The wire diameter and the number of coils in the spring 502 may vary.

The first end 538 of the spring 502 may be fixedly connected to a first surface 524 of the end cap 510. In one embodiment, portions of the spring 502 may be received in a recess 542 in the first surface 524 of the end cap 510. The second end 540 of the spring 502 biases against a second surface 516 of the valve stem 504. In the assembled configuration of the valve assembly VA as shown in FIG. 4, the spring 502 is configured to provide a constant spring force to force/bias the valve stem 504 towards the valve insert 508. When the valve assembly VA is in an assembled configuration, the spring 502 is configured to bias the valve stem 504 towards the O-ring 512 and the valve insert 508.

The valve stem 504 has a first surface 514 and the opposing second surface 516. The valve stem 504 also includes a base portion 518 and two valve stem portions 520 extending (e.g., perpendicularly away) from the base portion 518. The base portion 518 may include an engagement portion 544. The engagement portion 544 may have circular shaped configuration and may have a larger diameter (e.g., compared to two side portions 546 of the base portion 518). The enlarged diameter configuration of the engagement portion 544 is configured to facilitate the engagement of the engagement portion 544 of the valve stem 504 with the O-ring 512 and with the spring 502. For example, a first surface 548 of the engagement portion 544 is configured to engage with the O-ring 512 and an opposing second surface 550 of the engagement portion 544 is configured to engage with the spring 502.

The valve stem portions 520 may interchangeably referred to as valve stem legs. The valve stem portions 520 may have hollow cylindrical configuration with openings FO extending therethrough. The valve stem portions 520 are connected to the base portion 518 at their first ends 528 and have end portions 509 at their opposing, second ends 530. The end portions 509 may include heads FH of fasteners F. The fastener F may have the head FH and a body FB connected to the head FH. The bodies FB of the fasteners F may be received in openings FO of the valve stem portions 520 so as to threadedly connect the end portions 509 to the valve stem 504. The length of the openings FO of the valve stem portions 520 may vary to accommodate various fasteners F with longer/shorter fastener bodies with different fastener head sizes (e.g., head heights/widths).

The O-ring 512 may be a gasket (e.g., with a circular-loop shaped design) that is used to seal contacting surfaces between the valve stem 504 and the valve insert 508 to create an air-tight mating configuration, for example, when pressure is building up in the compression chamber 20 during the compression cycle. As will be explained in detail below, the O-ring 512 is configured to prevent air (e.g., high pressure air being built up in the compression chamber 20 during the compression cycle) from entering the drive cylinder 200 during the compression cycle. The O-ring 512 may be compressed by the valve stem 504 (due to the bias of the spring 502 on the valve stem 504) against the valve insert 508 resulting in zero clearance between the contacting surfaces of the valve stem 504 and the valve insert 508.

The valve insert 508 include two openings 522 that are configured to receive portions of the two valve stem portions 520 of the valve stem 504 respectively therein when the valve assembly VA is in the assembled configuration as shown in FIG. 4. The portions 509 of the valve stem 504 are configured to extend outwardly away from the valve insert 508 when the valve stem portions 520 of the valve stem 504 are received in the openings 522 in the valve insert 508. The openings 522 in the valve insert 508 are sized to allow passage of air/gas (e.g., from the compression cylinder 20) therethrough even when the valve stem portions 520 of the valve stem 504 are received in the openings 522 in the valve insert 508

The valve insert 508 includes a first surface 534, a second surface 536, and a protruding portion 532 extending from the second surface 536 (and towards the end cap 510). A surface 558 of the protruding portion 532 is configured to contact and engage with the surface 514 of the valve stem 504 when the valve assembly VA is in the assembled configuration.

The valve insert 508 includes a passageway 556 (disposed in the protruding portion 532) that is operationally disposed between the compression cylinder 20 and the drive cylinder 200. The passageway 556 may be disposed in a manner such that the passageway 556 communicates gas/air and a vacuum between the compression cylinder 20 and the drive cylinder 200. The term “gas” as used herein, refers to, but is not limited to “atmospheric air”. Herein, the terms “gas” and “air” are interchangeably used throughout the present patent application. [symbol] Inner surfaces of the %passageway 556 may be configured to facilitate movement of a head DMH of the driver/drive member 72 in the passageway 556. In one embodiment, a sealing member SM may be positioned between outer circumferential portions of the driver head DMH and the inner circumferential portions of the passageway 556 so as to provide a sealed configuration of the driver head DMH in the passageway 556.

The valve insert 508 also includes a recess 560 that is configured to receive portions of the driver 72 and the driver cylinder 200 therein when the valve assembly VA is in an assembled configuration. The outer surfaces 416 of the driver cylinder 200 is configured to engage with inner surfaces 562 of the recess 560. Sealing member SM' may be disposed between the outer surfaces 416 of the driver cylinder 200 and the inner surfaces 562 of the recess 560 to provide a sealed configuration between the driver cylinder 200 and the valve insert 508. The surfaces 564 of the recess 560 may be configured to engage with surfaces 566 of the driver 72 when the valve assembly VA is in assembled configuration.

The end cap 510 has the first surface 524 and an opposing second surface 526. The first surface 524 of the end cap 510 faces the second surface 516 of the valve stem 504. The first surface 524 of the end cap 510 is spaced apart from the second surface 516 of the valve stem 504 to define a valve chamber VC therebetween. That is, the valve assembly VA also includes the valve chamber VC between the second surface 516 of the valve stem 504 and the first surface 524 of the end cap 510 as shown in FIG. 6.

The end cap 510 also includes a recess 530 in the first surface 524. The recess 530 is configured to receive the protruding portion 532 of the valve insert 508 therein. In the assembled configuration of the valve assembly VA, the recess 530 of the end cap 510 receives the protruding portion 532 of the valve insert 508, with the spring 502, the valve stem 504 and the O-ring 512 positioned therebetween.

In the assembled configuration of the valve assembly VA, the first surface 524 of the end cap 510 may be in contact with the second surface 536 of the valve insert 508. Fasteners (not shown) may extend through openings 552 of the end cap 510 and openings 554 of the valve insert 508 to connect the end cap 510 to the valve insert 508. In one embodiment, other engaging members (e.g., flanges and flange receiving portions) or connectors may be disposed on the surfaces 524, 536 of the end cap 510 and valve insert 508, respectively, to facilitate the connection between the end cap 510 and the valve insert 508. The end cap 510 and the valve insert 508 form an upper end of the compression cylinder 20. For example, the inner surfaces 410 of the compression cylinder 20 are in contact with the outer surfaces UBOS of the end cap 510 and the valve insert 508. Sealing rings USR may be disposed between the inner surfaces 410 of the compression cylinder 20 and the outer surfaces UEOS of the end cap 510 and the valve insert 508 to provide a sealed configuration at the upper end of the compression cylinder 20.

As shown in FIG. 7, the fastening tool 10 may also include valve chamber VC′. The valve chamber VC′ may be defined by and between the surfaces of the valve insert 508 and the surfaces of the valve stem 504 when the valve assembly VA is in an assembled configuration. The valve chambers VC and VC′ are configured to be operatively connected to the compression cylinder 20. The valve chambers VC and VC′ is configured to be selectively operatively connected to the drive cylinder 200.

Referring to FIG. 7, the fastening tool 10 may also include a compression cylinder chamber CCC that is positioned in the compression cylinder 20, between the top surface TPS of the piston 50 and the surface 534 of the valve insert 508, and between the outer walls 416 of the drive cylinder 200 and the inner walls 410 of the compression cylinder 20. As shown in FIG. 7, the fastening tool 10 may also include a chamber C′ that is positioned between the bottom surface BPS of the piston 50, the surfaces of the compression cylinder 20, and the surfaces of the lower portion 570.

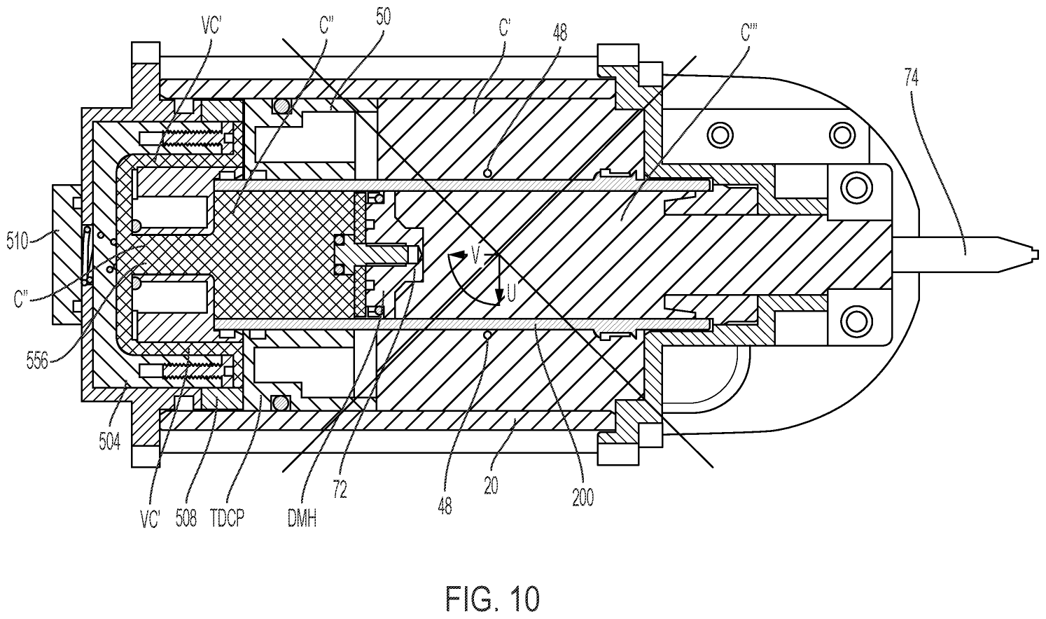

Referring to FIG. 7, the fastening tool 10 may also include a chamber C″ that is positioned above the head DMH of the driver 72. The chamber C″ may include portions of the passageway 556 and portions of the drive cylinder 200 that are positioned above the head DMH of the driver 72. Referring to FIGS. 7-9 and 13, the chamber C″ may include portions of the passageway 556. Referring to FIG. 10-12, the chamber C″ may include portions of the passageway 556 and portions of the drive cylinder 200 that are positioned above the head DMH of the driver 72.

Referring to FIG. 7, the fastening tool 10 may also include a chamber C″′ that is positioned below the head DMH of the driver 72. The chamber C″′ may include portions of the drive cylinder 200 that are positioned below the head DMH of the driver 72 and also portions of the lower portion 570.

The volume of and/or pressure in some of these chambers VC, VC′, CCC. C′, C″, and C″′ may change during the drive and return strokes of the driver member 72 and during the drive and compression strokes of the piston 50 as will be explained in detail below. The pressure in some of these chambers VC, VC′, CCC. C′, C″, and C″′ may remain constant during the drive and return strokes of the driver member 72 and during the drive and compression strokes of the piston 50. For example, the pressure in the chambers C′ and C″ is always at atmospheric pressure, although the volume of the chambers C′ and C″′ may vary (but may not be zero).

Also, referring to FIGS. 9 and 10, the volume of the chamber CCC is near zero or zero at the procedure where the piston 50 is near or at the top dead center position TDCP. This reduction of the volume of the chamber CCC may be compensated for by the increase of the volume in the chamber C′.

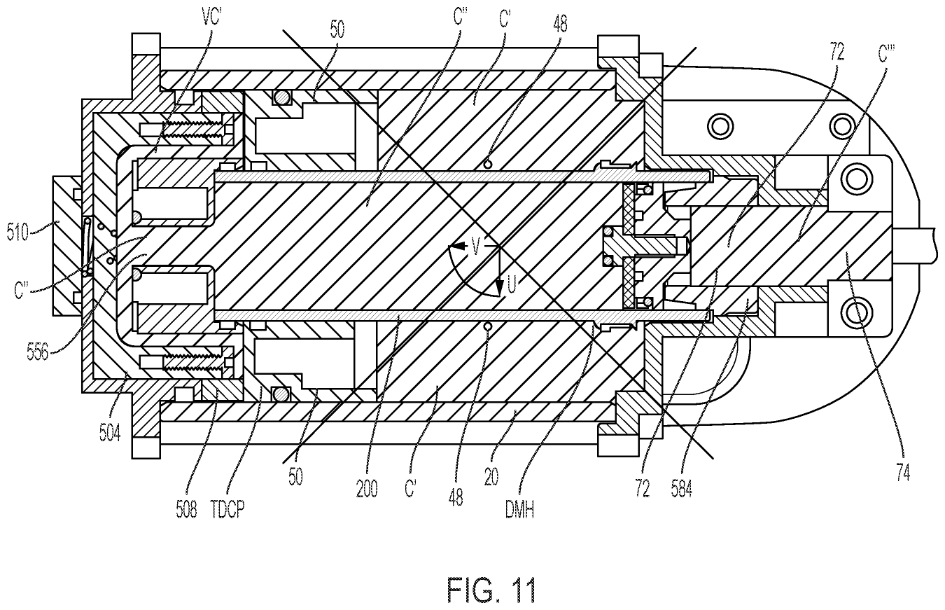

Referring to FIGS. 10-12, the volume of the chamber VC is zero at the procedure where the piston 50 is at the top dead center position TDCP. This reduction of the volume of the chamber VC may be compensated for by the increase of the volume in the chamber VC′. The pressure in the chamber VC′ changes from high pressure (FIG. 10) to atmospheric pressure (FIG. 11) to vacuum (FIG. 12).

Air intake vents 48 (as sho n in FIGS. 8.11) are arranged on a portion of the first compression chamber 20 to receive air. The air intake vents 48 draw in air from the housing 12 into the compression chamber 20 when the piston 50 moves from the bottom dead center position BDCP to the top dead center position TDCP. The compressed air generated in the first compression chamber 20 moves in the direction of arrow A (FIG. 2) and is channeled through apertures in the valve insert 66/508 to the second compression chamber or drive cylinder 200 in which the reciprocating driver member 72 is disposed. The driver member 72 is configured to drive a leading fastener along the drive axis DA out of the fastener drive track 26 and into the workpiece W. The driver member 72 may be provided in the housing 12 and may be configured for movement along the drive axis DA to drive a lead fastener into the workpiece W. The driver member 72 can have a driver blade 74 that impacts the fastener and drives the fastener into the workpiece W. Each drive cycle includes a drive stroke in which the driver member 72 moves from a home position at the top of the drive cylinder 200 toward the nosepiece assembly 24 along the drive axis DA and drives the leading fastener into the workpiece W, and a return stroke in which the driver member 72 is returned to its initial or home position so that it is ready for the next drive stroke. The direction of travel of the driver member 72, during the drive cycle, is shown by an arrow DT_{D} in FIGS. 1, 3 and 6. The direction of travel of the driver member 72, during the return stroke, is shown by an arrow DT_{R} in FIGS. 1, 3 and 6. %

FIGS. 3-9 illustrate an embodiment of the position biased release valve. The fastening tool 10 has a compression piston position release valve that releases the build-up of air in the compression cylinder 20 based on the position of the compression piston 50.

An operation cycle of driving the fastener refers to steps/procedures involved in driving the fastener completely into the workpiece W from the fastener driving apparatus/fastening tool 10. The operation cycle may also be termed as a combination of a compression stroke/cycle and a return stroke/cycle of the piston 50. [symbol] The piston 50 is reciprocally movable within the compression cylinder 20 to execute the compression stroke and the return stroke. The piston 50 executes the compression stroke and return stroke with help of the motor and drive assembly. Operation of the motor is further controlled by the control circuit/controller. The gas passageway 556 is configured to pneumatically connect the compression cylinder 20 and the drive cylinder 200.

When the tool 10 is at rest, all of the chambers including a compression cylinder 20 are at rest. The tool 10 then drives the compression piston 50 to the rear/left of the valve to increase the pressure in the compression cylinder 20. During the compression stroke of the piston 50 in the compression cylinder 20, the piston 50 is configured to move towards the top dead center position TDCP of the compression cylinder 20, thereby compressing gas in the gas chamber CCC formed above the upper/top face TPS of the piston 50 in the compression cylinder 20 to a predetermined pressure or a predetermined stroke of the piston 50. The direction of travel of the piston 50, during the compression stroke, is shown by an arrow PT_{c} in FIGS. 3 and 6. The direction of travel of the piston 50, during the return stroke, is shown by an arrow PT_{R} in FIGS. 3 and 6.

During the compression cycle, the piston 50 is moved by the drive assembly 40′ from the bottom dead center position BDCP to the top dead center position TDCP to increase the pressure in the compression cylinder 20. During the compression cycle, the valve stem 504 is held against the O-ring 512 and the valve insert 508 to form a seal between the valve stem 504 and the valve insert 508 using the O-ring 512 so as to seal off the driver cylinder 200 from the valve chambers VC and VC′. The valve stem 504 is held against the valve insert 508 and the O-ring 512 by bias of the valve stem spring 502 and by the pressure of air in the valve chamber VC.

During compression, the valve stem 504 is held against the face seal O-ring 512 by the valve stem spring 502 and by pressure behind the valve stem 504. This seals off the driver member 72 from the high pressure that is building behind the valve stem. When the compression piston 50 reaches the top dead center position TDCP, the piston face contacts the valve stem arms. As a result of the compression piston 50 contacting the valve stem arms, the compression piston 50 forces the valve stem 502 to break the seal on a face seal O-ring 512, allowing high pressure to enter the drive cylinder 200 and propel the driver member 72 forward to strike a fastener. The driver blade 74 coupled to the driver 72 also moves linearly with the movement of the driver 72 and strikes the fastener, thereby driving the fastener into the workpiece W.

After the driver member 72 has driven the nail into the workpiece W, any remaining pressure is exhausted through the one-way check valve on the drive cylinder 200 and the tool 10 returns to atmospheric pressure. The one-way check valve is an exhaust valve that is configured to exhaust any remaining pressure from the driver cylinder 200 after the driver member 72 has driven the lead fastener into the workpiece W so that the fastening tool 10 returns to an atmospheric pressure.

During the return stroke of the piston 50 in the compression cylinder 20, the piston 50 is configured to move towards the bottom dead center of the compression cylinder 20. Movement of the piston 50 towards the bottom dead center of the compression cylinder 20 creates a vacuum between the top dead center of the compression cylinder 20 and the piston 50. The vacuum created in the compression cylinder 20 is communicated to the drive cylinder 200.

That is, when the compression piston 50 returns to the bottom dead center position BDCP (i.e., from the top dead center position TDCP), the compression piston 50 draws the vacuum in the drive cylinder 200. The vacuum causes the driver member 72 to return to its rest position and all chambers to return to atmospheric pressure. In this state, the valve stem spring 502 biases the valve stem 504 to seal against the face of the seal O-ring 512. Therefore, based on the position of the compression piston 50, the release valve VA can be opened in order to actuate the driver member 72 to drive the nail/fastener into the workpiece W.

In one embodiment, a method of operating the fastening tool 10 (that is described in detail above) is provided. The method comprises actuating the drive assembly 40′ (and the motor 44) to move the piston 50 to travel between the at least two positions in the compression cylinder 20; and engaging the piston 50 with the valve assembly VA to open the valve assembly VA and to release the buildup of air in the compression cylinder 20, due to the travel of the piston between the at least two positions in the compression cylinder 20, to the drive cylinder 200 so as to move the driver member 72 along the drive axis DA to drive the lead fastener into the workpiece W.

The method of operation of the fastening tool 10 will also be described with respect to FIGS. 7-13.

Referring to FIG. 7, the fastening tool 10 is at rest. All the chambers of the fastening tool 10, including chambers VC, VC′, CCC, C′, C″, and C″′ are shaded using single lines to show that the chambers VC, VC′, CCC, C′, C″, and C″′ are all at atmospheric pressure. In this configuration, the chambers VC and VC′ are open to the compression cylinder 20 and are sealed off (not open to) from the drive cylinder 200. The piston 50 is positioned at its bottom dead center position BDCP. the chambers VC and VC′ are sealed off (not open to) from the drive cylinder 200 as the valve stem 504 is held against the O-ring 512 and the valve insert 508 by the bias of the spring 502. The driver 72 is at the topmost position in the driver cylinder 200.

Referring to FIG. 8, the fastening tool 10 drives the compression piston 50 from its bottom dead center position BDCP (in FIG. 7) to its top dead center position TDCP during the compression cycle. In FIG. 8, the compression piston 50 is shown to be at an intermediate position IP between its bottom dead center position BDCP and its top dead center position TDCP. The driver 72 is still at the topmost position in the driver cylinder 200

During the compression cycle, as the piston 50 is being moved from its bottom dead center position BDCP (in FIG. 7) to its top dead center position TDCP, the pressure in the chamber CCC of the compression cylinder 20 increases as the volume of the chamber CCC decreases. As the chambers VC and VC′ are open to and connected to the chamber CCC of the compression cylinder 20, the pressure in the chambers VC and VC′ also increases. Thus, during the compression cycle, as the piston 50 is being moved from its bottom dead center position BDCP (in FIG. 7) to its top dead center position TDCP, the pressure in the chambers VC, VC′, and CCC increases from atmospheric pressure to a first high pressure (i.e., higher than the atmospheric pressure). The valve stem 504 is still held against the O-ring 512 and the valve insert 508 by the bias of the spring 502 and also by the high pressure in the chamber VC.

In the configuration of FIG. 8, the chambers C′, C″, and C″′ are shaded using single lines to show that the chambers C′, C″, and C″′ are still at atmospheric pressure. In FIG. 8, the chambers VC, VC′, and CCC are shaded using double hatched lines to show that the chambers VC, VC′, and CCC are at high pressure (e.g., the first high pressure).

Referring to FIG. 9, the fastening tool 10 drives the piston 50 to its top dead center position TDCP. In this configuration, the piston 50 contacts the end portions 509 of the valve stem 504. In FIG. 9, the pressure in the chambers VC and VC′ further increases from the first high pressure to a second high pressure (i.e., higher than atmospheric pressure and the first high pressure). In the configuration of FIG. 9, the chambers C′, C″, and C″′ are shaded using single lines to show that the chambers C′, C″, and C″′ are still at atmospheric pressure. In FIG. 9, the chambers VC and VC′ are shaded using multiple hatched lines to show that the chambers VC and VC′ are at the second high pressure. In one embodiment, portions of the chamber VC′ are at the second high pressure, while portions of the chamber VC′ (closer to the piston 50) may be at the first high pressure.

Referring to FIG. 10, the piston 50 is at its top dead center position TDCP and the piston 50 engages and forces the end portions 509 of the valve stem 504 (i.e., toward the end cap 510), against the bias of the spring 502 and against the second high pressure of air in the valve chamber VC, to break the seal between the valve stem 504, the O-ring 512 and the valve insert 508 so as to allow the high pressure air in the valve chambers VC and VC′ to enter the drive cylinder 200. The high pressure air entering the drive cylinder 200 is configured to enter at the top of the head DMH of the driver 72 to move/push/force the driver member 72 along the drive axis DA to drive the lead fastener into the workpiece W.

That is, the piston 50 forces the valve stem 504 to break the seal on the face seal O-ring 512. The high pressure air/gas in the chambers VC and VC′ thus enters the drive cylinder 200 and propels the driver 72 forward. Once the seal between the valve stem 504 and face seal O-ring 512 is broken, the high air pressure air now has a path to enter the drive cylinder 200 (e.g., through the passageway 556). The expansion and the flow of air into the drive cylinder 200 from the compression cylinder 20 keeps the valve stem 504 open until the pressure differential is negated.

In FIG. 10, the pressure in the chambers VC′ and C″ are shaded using multiple or double hatched lines to show that the chambers VC′ and C″ are at high pressures (i.e., second high pressure with some portions at first high pressure, and higher than atmospheric pressure). In the configuration of FIG. 10, the chambers C′ and C″′ are shaded using single lines to show that the chambers C′ and C″′ are still at atmospheric pressure.

Referring to FIG. 10, the chamber VC′ also includes the space between the valve stem 504 and the valve insert 508, where this space is filled with the high pressure air. Also, in FIG. 10, the chamber C″ includes both the passage 556 and portions of the drive cylinder 200 that are positioned above the head DMH of the driver 72. The chamber C″, including the passage 556 and portions of the drive cylinder 200 that are positioned above the head DMH of the driver 72, is filled with the high pressure air.

Referring to FIG. 11, the driver 72 reaches the front bumper 584 after nail/fastener is driven into the workpiece W. The pressure is exhausted through one way check/exhaust valve on the drive cylinder 200. The fastening tool 10 tool returns to the atmospheric pressure. At this point in the drive cycle, the valve stem 504 may return to its resting position briefly (not shown in diagram).

Referring to FIG. 11, the chambers VC′, C′, C″, and C″′ are shaded using single lines to show that the chambers VC′, C′, C″, and C″′ are at atmospheric pressure. In this configuration, the chamber VC′ is open (to the compression cylinder 20 and) to the chamber C″ of the drive cylinder 200. The piston 50 is positioned at its top dead center position TDCP.

As shown in FIG. 12, as compression piston 50 returns to the bottom dead center position BDCP, the piston 50 draws a vacuum in the compression chamber 20. This vacuum causes the driver 72 to return to its rest position (i.e., at the top of the drive cylinder 200). When a vacuum is present within the compression chamber 20, the valve stem 504 acts as a one way valve. This causes the vacuum to be observed in the drive cylinder 200 and returns the driver 72 due to the pressure differential.

Referring to FIG. 12, the chambers VC′, C″, and CCC are shaded using circles to show that the chambers VC′, C″, and CCC are at vacuum. In this configuration, the chamber VC′ is open to the compression cylinder 20 and to the chamber C″ the drive cylinder 200. The chamber VC′ includes the space between the valve stem 504 and the valve insert 508, where this space is filled with vacuum. The chamber C″ includes both the passage 556 and portions of the drive cylinder 200 that are positioned above the head DMH of the driver 72. The chamber C″, including the passage 556 and portions of the drive cylinder 200 that are positioned above the head DMH of the driver 72, is filled with vacuum. The piston 50 is positioned at its intermediate position IP between its bottom dead center position BDCP and its top dead center position TDCP. The chambers C′ and C″′ are shaded using single lines to show that the chambers C′ and C″′ are at atmospheric pressure.

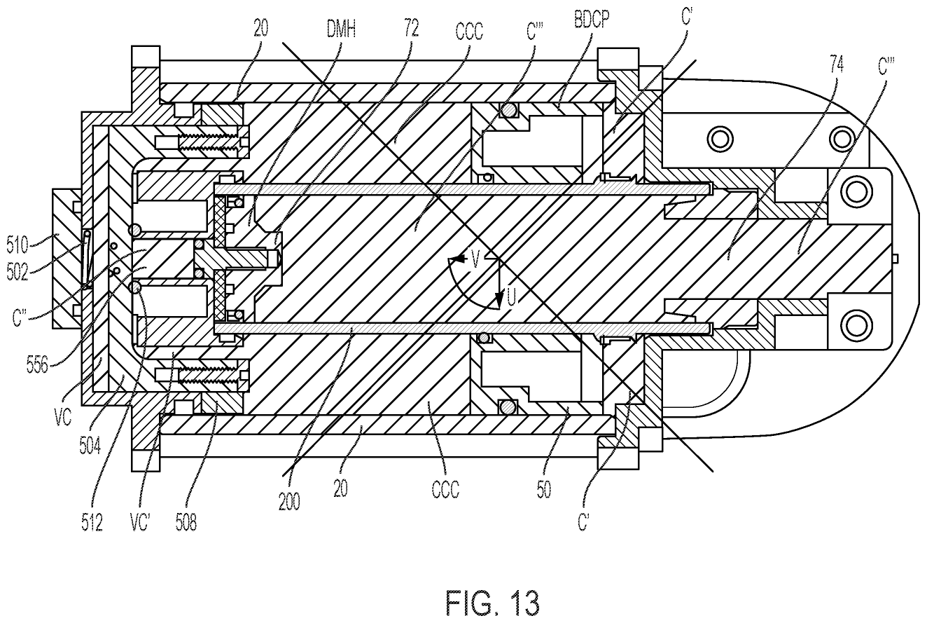

FIG. 13, the piston 50 reaches its bottom dead center position BDCP, all chambers VC, VC′, CCC, C′, C″, and C″′ return to atmospheric pressure. The valve stem spring 502 biases the valve stem 504 to seal against the face seal O-ring 512 and the valve insert 508. The fastening tool 10 is now fully returned to the state shown in FIG. 7 and ready to be fired again.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of this application.

While aspects of the present patent application are described herein and illustrated in the accompanying drawings in the context of a fastening tool, those of ordinary skill in the art will appreciate that the present patent application, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not to be limited to the particular examples illustrated by the drawings and described in the specification as the best mode presently contemplated for carrying out the teachings of the present disclosure, but that the scope of the present disclosure will include any embodiments falling within the foregoing description.

What is claimed is:

1. A fastening tool comprising:
a housing;
a nosepiece assembly connected with the housing and including a fastener drive track having a drive axis;
a magazine assembly for feeding a number of fasteners successively along a fastener channel of the fastener drive track;
a driver member provided in the housing and configured for movement along the drive axis to drive a lead fastener into a workpiece;
a motor disposed in the housing;
a power source configured to provide power to the motor;
a controller disposed in the housing and configured to control a supply of power from the power source to the motor and to initiate a drive cycle;
a compression cylinder assembly disposed in the housing, the compression cylinder assembly comprising a compression cylinder and a piston that is configured to travel between at least two positions in the compression cylinder;
a drive assembly operatively connected to the motor, the drive assembly operatively connected to the piston to facilitate the travel of the piston in the compression cylinder;
a drive cylinder disposed in the housing, the driver member at least partially disposed within the drive cylinder for movement along the drive axis, the drive cylinder being operatively connected with the compression cylinder; and
a valve assembly operatively connected with drive cylinder and the compression cylinder,
wherein the piston is configured to engage with and open the valve assembly to release the buildup of air in the compression cylinder, due to the travel of the piston between the at least two positions in the compression cylinder, to the drive cylinder so as to move the driver member along the drive axis to drive the lead fastener into the workpiece.

2. The fastening tool of claim 1, wherein the valve assembly is a piston position biased release valve assembly.

3. The fastening tool of claim 1, wherein the valve assembly includes a spring and a valve portion,
wherein the spring is configured to bias the valve portion to close the valve assembly, and
wherein the piston is configured to engage with and force the valve portion, against the bias of the spring, to open the valve assembly.

4. The fastening tool of claim 1, wherein the valve assembly comprises a valve stem, a valve stem spring, a valve insert, an end cap, and an O-ring, and
wherein the valve stem spring is configured to bias the valve stem towards the O-ring and the valve insert to close the valve assembly.

5. The fastening tool of claim 4, wherein the valve stem has a first surface and an opposing second surface,
wherein the valve stem also includes a base portion and two valve stem portions extending from the base portion, and
wherein the valve insert include two openings configured to receive the two valve stem portions of the valve stem respectively therein.

6. The fastening tool of claim 5, wherein the end cap has a first surface and an opposing second surface, the first surface of the end cap facing the second surface of the valve stem,
wherein the valve assembly also includes a valve chamber between the second surface of the valve stem and the first surface of the end cap,
wherein the valve chamber is configured to be operatively connected to the compression cylinder, and
wherein the valve chamber is configured to be operatively connected to the drive cylinder when the valve assembly is open.

7. The fastening tool of claim 6, wherein the at least two positions in the compression cylinder between which the piston travels include a top dead center position and a bottom dead center position, and
wherein the top dead center position is positioned near the valve assembly.

8. The fastening tool of claim 7, wherein, during a compression cycle, the piston is moved by the drive assembly from the bottom dead center position to the top dead center position to increase the pressure in the compression cylinder,
wherein, during the compression cycle, the valve stem is held against the O-ring and the valve insert to form a seal between the valve stem, the O-ring and the valve insert so as to seal off the driver cylinder from the compression cylinder, and
wherein the valve stem is held against the O-ring and the valve insert by bias of the valve stem spring.

9. The fastening tool of claim 8, wherein, when the piston reaches the top dead center position,
1) the valve stem is held against the O-ring and the valve insert by bias of the valve stem spring and by the pressure of air in the valve chamber; and
2) the piston contacts and forces the valve stem, against the bias of the valve stem spring and against the pressure of air in the valve chamber, to break the seal between the valve stem, the O-ring and the valve insert so as to allow the air in the valve chamber and the compression cylinder to enter the drive cylinder, and
wherein the air entering the drive cylinder is configured to move the driver member along the drive axis to drive the lead fastener into the workpiece.

10. The fastening tool of claim 9, further comprising an exhaust valve that is configured to exhaust any remaining pressure from the driver cylinder after the driver member has driven the lead fastener into the workpiece so that the fastening tool returns to an atmospheric pressure.

11. The fastening tool of claim 10, wherein the exhaust valve is a one-way check valve.

12. The fastening tool of claim 10, wherein the drive cycle includes a drive stroke in which the driver member moves from a home position at the top of the drive cylinder toward the nosepiece assembly along the drive axis and drives the lead fastener into the workpiece, and a return stroke in which the driver member is returned to its home position so that the driver member is ready for the next drive stroke.

13. The fastening tool of claim 12, wherein, when the piston is returned from the top dead center position to the bottom dead center position by the drive assembly, the piston draws vacuum into the drive cylinder,
wherein the vacuum is configured to cause the driver member to return to its home position and the fastening tool to return to the atmospheric pressure, and
wherein the valve stem spring is configured to bias the valve stem to be held against the O-ring and the valve insert to form the seal between the valve stem and the O-ring when the driver member has returned to its home position.

14. The fastening tool of claim 13, wherein the housing includes a trigger assembly that activates the drive cycle that causes the piston to travel between at least two positions within the compression cylinder, and
wherein the controller is configured to connect the trigger assembly to the drive assembly.

15. The fastening tool of claim 14, wherein the housing defines a handle portion, and wherein the trigger assembly is connected to the housing, adjacent to the handle portion.

16. The fastening tool of claim 15, wherein the drive assembly includes a drive shaft that is operatively connected to the piston to facilitate the travel of the piston in the compression cylinder.

17. A method of operating a fastening tool, the fastening tool comprising a housing; a nosepiece assembly connected with the housing and including a fastener drive track having a drive axis; a magazine assembly for feeding a number of fasteners successively along a fastener channel of the fastener drive track; a driver member provided in the housing and configured for movement along the drive axis to drive a lead fastener into a workpiece; a motor disposed in the housing; a power source configured to provide power to the motor; a controller disposed in the housing and configured to control a supply of power from the power source to the motor and to initiate a drive cycle; a compression cylinder assembly disposed in the housing, the compression cylinder assembly comprising a compression cylinder and a piston that is configured to travel between at least two positions in the compression cylinder;
a drive assembly operatively connected to the motor, the drive assembly operatively connected to the piston to facilitate the travel of the piston in the compression cylinder; a drive cylinder disposed in the housing, the driver member at least partially disposed within the drive cylinder for movement along the drive axis, the drive cylinder being operatively connected with the compression cylinder; and a valve assembly operatively connected with drive cylinder and the compression cylinder, the method comprising:
actuating the drive assembly to move the piston to travel between the at least two positions in the compression cylinder; and
engaging the piston with the valve assembly to open the valve assembly and to release the buildup of air in the compression cylinder, due to the travel of the piston between the at least two positions in the compression cylinder, to the drive cylinder so as to move the driver member along the drive axis to drive the lead fastener into the workpiece.
